(19) United States
(12) Patent Application Publication
(10) Pub. No.: US 2025/0259315 A1
(43) Pub. Date: Aug. 14, 2025

(54) TARGET RECOGNITION SYSTEM, TARGET RECOGNITION METHOD, AND NON-TRANSITORY COMPUTER-READABLE MEDIUM

(71) Applicant: TOYOTA JIDOSHA KABUSHIKI KAISHA, Toyota-shi (JP)

(72) Inventors: Daisuke KAKUMA, Susono-shi (JP); Tatsuya Sugano, Sunto-gun (JP); Hiroya Chiba, Fuji-shi (JP)

(73) Assignee: TOYOTA JIDOSHA KABUSHIKI KAISHA, Toyota-shi (JP)

(21) Appl. No.: 18/980,364

(22) Filed: Dec. 13, 2024

(30) Foreign Application Priority Data
Feb. 13, 2024 (JP) 2024-019349

(51) Int. Cl. G06T 7/254; G06V 20/52

(52) U.S. Cl. CPC G06T 7/254; G06V 20/52; G06V 2201/07

(57) ABSTRACT

A target recognition system recognizes a target shown in an image captured by an infrastructure camera. The target recognition system detects a first target shown in the image as a temporary target. When a class of the temporary target is a movable target, the target recognition system applies a tracking process to the temporary target and determines that the first target is a real movable target based on a result of detection of the temporary target in a first period. When the class of the temporary target is a stationary target, the target recognition system determines that the first target is a real stationary target based on a result of detection of the temporary target in a second period without applying the tracking process to the temporary target.

### CROSS-REFERENCE TO RELATED APPLICATION

This application claims priority to Japanese Patent Application No. 2024-019349 filed on Feb. 13, 2024, the entire contents of which are incorporated by reference herein.

### TECNICAL FIELD

The present disclosure relates to a target recognition technique for recognizing a target shown in an image captured by an infrastructure camera.

### BACKGROUND ART

Patent Literature 1 discloses a radar module detecting stationary and movable objects. The radar module includes a stationary object process unit that processes a signal relating to a stationary object and a movable object process unit that processes a signal relating to a movable object. The radar module further includes a switching unit that switches between the process by the stationary object process unit and the process by the movable object process unit. The radar module detects the stationary object and the movable object in different steps (that is, at different timings).

Non-Patent Literature 1 discloses a tracker called “ByteTrack”.

### List of Related Art

Patent Literature 1: Japanese Patent Application Laid-Open No. 2021-143924

Non-Patent Literature 1: Zhang et al., “ByteTrack: Multi-Object Tracking by Associating Every Detection Box,” arXiv: 2110. 06864v3 [cs. CV], April 2022 (https://arxiv.org/abs/2110.06864)

### SUMMARY

It is considered that a target shown in an image captured by an infrastructure camera is recognized. In order to reduce false detections of the target, a tracking process can be applied to the target detected in the image, and it is determined that the target is a real target. However, since the tracking process is complicated, its processing load increases and the computational resource is consumed.

An object of the present disclosure is to provide a target recognition technique that can reduce the processing load when a target shown in an image captured by an infrastructure camera is recognized.

A first aspect relates to a target recognition system that recognizes a target shown in an image captured by an infrastructure camera.

The target recognition system includes:
processing circuitry configured to:
   detect a first target shown in the image as a temporary target;
   when a class of the temporary target is a movable target, apply a tracking process to the temporary target and determine that the first target is a real movable target based on a result of detection of the temporary target in a first period; and
   when the class of the temporary target is a stationary target, determine that the first target is a real stationary target based on a result of detection of the temporary target in a second period without applying the tracking process to the temporary target.

A second aspect has the following aspect in addition to the first aspect.

The processing circuitry outputs a result of determining that the first target is the real movable target or the real stationary target to a subsequent process.

A third aspect relates to a target recognition method for recognizing a target shown in an image captured by an infrastructure camera.

The target recognition method includes:
detecting a first target in the image as a temporary target;
when a class of the temporary target is a movable target, applying a tracking process to the temporary target, and determining that the first target is a real movable target based on a result of the detection of the temporary target in a first period; and
when the class of the temporary target is a stationary target, determining that the first target is a real stationary target based on a result of the detection of the temporary target in a second period without applying the tracking process to the temporary target.

A fourth aspect relates to a non-transitory computer-readable recording medium on which a target recognition program is recorded.

The target recognition program is for recognizing a target shown in an image captured by an infrastructure camera.

The target recognition program, when executed by a computer, causes the computer to execute:
detecting a first target in the image as a temporary target;
when a class of the temporary target is a movable target, applying a tracking process to the temporary target, and determining that the first target is a real movable target based on a result of the detection of the temporary target in a first period; and
when the class of the temporary target is a stationary target, determining that the first target is a real stationary target based on a result of the detection of the temporary target in a second period without applying the tracking process to the temporary target.

According to the first aspect, the target shown in the image is first detected as the temporary target. If the class of the temporary target is the movable target, the tracking process is performed to determine that the temporary target is the real movable target. On the other hand, if the class of the temporary target is the stationary target, the position of the temporary target should not change in the image, and thus the complicated tracking process is considered unnecessary. Therefore, if the class of the temporary target is the stationary target, the temporary target is determined to be the stationary target without performing the complex tracking process. As a result, the processing load is reduced and computational resources are saved compared to the case where the tracking process is applied to all targets regardless of the class. This effect would be more prominent as the number of targets simultaneously shown in the image increases.

Further, according to the second aspect, by outputting the result of the recognition of the target whose real existence is determined to the subsequent process, it is possible to reduce unnecessary processing and operation of the subsequent process caused by false detections. This leads to a reduction in processing load of the subsequent process. Further, frequent occurrence of unnecessary processes and operations (for example, detection of a virtual abnormality by an abnormality monitoring system in cities) may lead to user's anxiety and distrust. Therefore, the target recognition system contributes to increase the reliability of the subsequent process.

### BRIEF DESCRIPTION OF DRAWINGS

FIG. 1 is a diagram for explaining an outline of a tracking process;

FIG. 2 is a schematic diagram for explaining the tracking process for each time step;

FIG. 3 is a diagram for explaining an overview of a target recognition system according to the present embodiment.

FIG. 4 is a schematic diagram for explaining a simplified determination process for each time step;

FIG. 5 is a schematic diagram for explaining an example of an existence determination condition;

FIG. 6 is a schematic diagram illustrating another example of the existence determination condition;

FIG. 7 is a block diagram showing an example of the configuration of the target recognition system; and

FIG. 8 is a flowchart for explaining a series of processes related to the target recognition system.

### DETAILED DESCRIPTION

Embodiments of the present disclosure will be described with reference to the drawings.

### 1. TARGET DETECTION IN VIDEO

A technique for detecting a target from a video captured by an infrastructure camera (target detection algorithm) is known. The target detection algorithm automatically detects a target shown in the video by learning features of various types of targets (objects to be detected) in advance. A result of detection of the target is output to subsequent processes and used in various forms. Examples of the subsequent processes include abnormality monitoring in a city, control of automated valet parking (AVP) in a parking lot, etc.

However, the target detection algorithm may falsely detect a target that does not actually exist (hereinafter, referred to as “false detection”). Here, when the result of the detection including the false detection is immediately output to a subsequent process (for example, abnormality monitoring in a city), the abnormality monitoring is executed based on the input detection result. When the detection result includes a target that is falsely detected (that is, a non-existent imaginary target), an abnormality may be detected for the imaginary target. This is a meaningless monitoring in which the target does not exist, and a computational load caused by the unnecessary process is generated. Further, if the false detection is repeated, the user who uses the abnormality monitoring system may feel anxious.

In order to prevent the detection result including the false detection from being output to the subsequent process, it is necessary to output the detection result to the subsequent process after it is determined that the detected target really exists. For example, the detection result of the target by the target detection algorithm may be set as a temporary result, and thereafter, the target detection may be continued for a certain period of time, and when a specific condition is satisfied, it may be determined that the detected target really exists (existence determination). Thereafter, if the result in which the real existence of the target determined is output to the subsequent process, the possibility that the detection result including the false detection is output to the subsequent process is reduced.

For example, the existence of the target can be determined through a “tracking process”. The tracking process is a process of continuously tracking a target detected in the video. The tracking process will be described below.

### 1-1. Tracking Process

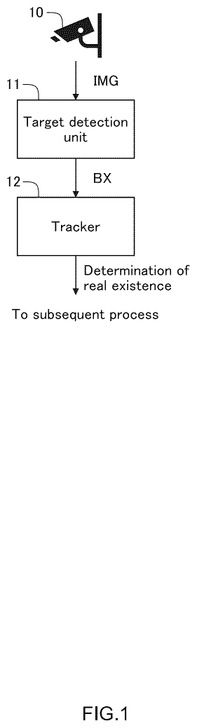

FIG. 1 is a diagram for explaining an outline of the tracking process. The video captured by the infrastructure camera 10 is transmitted to a target detection unit 11 as a frame (a still image for each frame constituting the video). In the present embodiment, a series of frames constituting video is defined as a serial images IMG. The target detection unit 11 detects a target and its class from the serial images IMG by using a target detection algorithm. The class indicates the type of the target, such as a vehicle, a pedestrian, a bicycle, a traffic light, and a tree. The target detection unit 11 further provides a bounding box BX around the detected target. The bounding box BX represents the position of the target in the serial images IMG. For example, the target detection unit 11 includes a machine learning model that has learned to detect a target and its class from the image IMG. The target detection unit 11 can detect a target and its class in the image IMG by inputting the image IMG to the machine learning model, and can provide the bounding box BX around the target. The target detection unit 11 transmits information on the bounding box BX and the class of the target included in the serial images IMG to the tracker 12. The tracker 12 automatically tracks the same target in the serial images IMG based on a tracking algorithm. For example, “ByteTrack”, described in Non-Patent Literature 1, is known as a powerful tracker.

In order for the tracker 12 to perform tracking, the target needs to be continuously detected over a predetermined period of time. This is because the target cannot be tracked unless the target itself is detected. That is, if the tracking process is appropriately executed for a certain target, it can be said that the target is highly likely to exist. On the other hand, if the target is not detected in the middle of the tracking process, the possibility that the target actually exists is low. In this way, the existence of the target can be determined by applying the tracking process. If the result indicating that the existence is determined is output to the subsequent process as the final result of recognition, more useful information is output in the subsequent process.

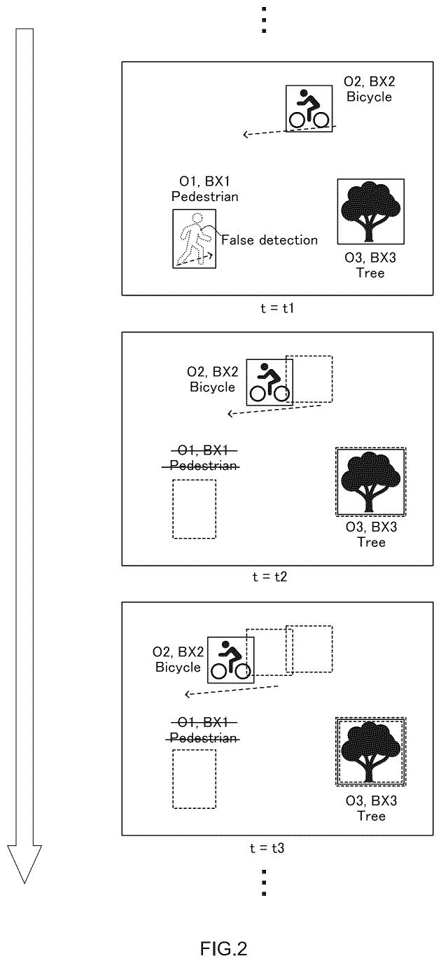

FIG. 2 is a schematic diagram for explaining the tracking process for each time step. FIG. 2 shows the serial images IMG at different time steps (t=t1, t2, t3, . . . ) included in the video.

When a target moves, the bounding box BX representing the target also moves in the serial images IMG. Bounding boxes BX representing the same target in the serial images IMG of different time steps are spatially consecutive. Therefore, by focusing on the movement of the bounding box BX, it is possible to specify a plurality of bounding boxes BX representing the same target in the serial images IMG. This makes it possible to track the same target in the serial images IMG.

The tracker 12 (i.e. the tracking algorithm) tracks the same target in the serial images IMG based on the movement of the bounding box BX. More particularly, the tracker tracks the same target in the serial images IMG by identifying a plurality of bounding boxes BXi representing the same target in the serial images IMG. Here, i (1, 2, 3, . . . ) is an identifier of a plurality of bounding boxes BX representing the same target. The tracker 12 associates with a plurality of bounding boxes BXi representing the same movable target in a serial images IMG of different time steps. It should be noted that the tracker 12 does not require feature extraction to track the same target. The tracker 12 tracks the same target based on the movement of the bounding box BX without performing feature extraction.

At t=t1, there are three targets (O1˜O3) detected by the target detection unit 11. The respective target is provided with corresponding bounding boxes BX1 to BX3. The target detection unit 11 also detects the class of each target. In the case of FIG. 2, the classes of target O1 to O3 are a pedestrian, bicycle, and a tree, respectively. Here, it is assumed that the target O1 does not really exist and is falsely detected. The tracker 12 predicts the movement of each of the bounding boxes BX. For example, the tracker 12 may predict the movement tendency of each of the bounding boxes BX by using the position information of each of the bounding boxes BX before t=t1. Using this information, the tracker 12 can predict the position at which each of the bounding boxes BX will be detected at the next time step (t=t2).

At t=t2 and t3, the tracker 12 successfully track the bounding box BX2 and the bounding box BX3. On the other hand, the tracker 12 fails to track the bounding box BX1 at t=t2 and t3. Here, it is assumed that the tracker 12 predicts that the bounding box BX1 can be tracked even at t=t2 from the situation at t=t1. Nevertheless, bounding box BX1 is not detected at t=t2 and t3. Therefore, the tracker 12 can determine that the bounding box BX1 corresponding to the target O1 is not a real existing target and the target detection unit 11 has falsely detected the target O1. In this way, the false detection of the target can be correctly determined through the tracking process.

However, the tracking process includes a complicated process such as prediction by combining the position information of each bounding box BX and the time series, and thus the processing load tends to be large. In particular, when multiple targets are included in an image and the tracking process is applied to the multiple targets in parallel, the increase in the processing load is significant. Considering this viewpoint, the present embodiment discloses a target recognition technique which reduces the processing load when recognizing a target shown in an image captured by an infrastructure camera.

### 2. TARGET RECOGNITION SYSTEM IN THE PRESENT DISCLOSURE

### 2-1. Overview

A target recognition system 1 in the present disclosure classifies a detected target as a “movable target” or a “stationary target” based on its class. Thereafter, the target recognition system 1 determines whether the stationary target actually exists or is falsely detected without the tracking process.

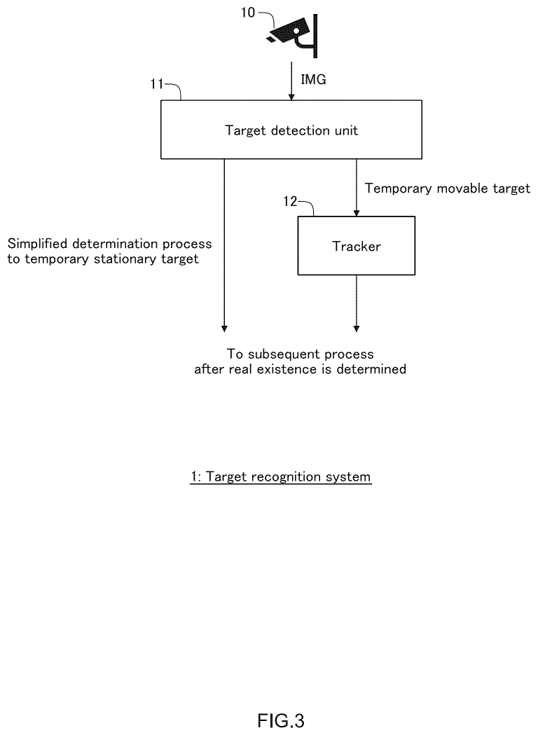

FIG. 3 is a diagram for explaining an overview of the target recognition system 1 according to the present embodiment. The target detection unit 11 executes the same process as that of FIG. 1. That is, the target detection unit 11 detects a target (which may be referred to as a first target) and its class in the serial images IMG, and provides the bounding box BX. At this stage, the target may be falsely detected. For convenience of explanation, a target detected by the target detection unit 11 is referred to as a “temporary target”.

The temporary target detected by the target detection unit 11 in the target recognition system 1 is classified into “movable target” or “stationary target”. The movable target is a target that potentially moves, and the stationary target is a target that does not move. Examples of movable targets include vehicles, pedestrians, bicycles, animals, etc. On the other hand, examples of stationary targets include traffic lights, trees, poles, guardrails, etc. It should be noted that whether a target is a movable target or a stationary target is determined by whether the target is movable as a property of the target, not by moving or being stationary at the time of detection by the target detection unit 11. For example, if the target detection unit 11 detects a parked vehicle, the vehicle is classified as a movable target because the vehicle potentially moves. The target detection unit 11 learns the class of the target (vehicle, pedestrian, etc.) in association with the classification (movable/stationary), and thus a class of a target includes information on movable/stationary. For convenience of explanation, among the temporary targets detected by the target detection unit 11, the temporary target classified as a movable target is referred to as a “temporary movable target”, and the temporary target classified as a stationary target is referred to as a “temporary stationary target”.

Temporary stationary targets should not move when viewed from the infrastructure camera 10. In other words, the position of a temporary stationary target should not change in the image IMG. Therefore, the complicated tracking process is not always necessary for the temporary stationary target. From this viewpoint, the target recognition system 1 determines whether the temporary target actually exists or not, by performing different processes on the temporary movable target and the temporary stationary target. The target recognition system 1 applies the tracking process described above to the temporary movable target. The tracker 12 execute the tracking process. On the other hand, the target recognition system 1 executes a “simplified determination process” described below for the temporary stationary target, instead of the tracking process. Specifically, the target detection unit 11 executes the simplified determination process. Information on the temporary target determined to actually exist by the tracking process or the simplified determination process is output to a subsequent process.

### 2-2. Simplified Determination Process

The simplified determination process is a process of determining whether the temporary stationary target really exists, without applying the tracking process. Specifically, the target detection unit 11 continues to detect the temporary stationary target for a predetermined period even after the temporary stationary target is detected. Based on its result, the target detection unit 11 determines whether the temporary stationary target really exists. The target detection unit 11 determines whether the temporary stationary target exists based on “whether the temporary stationary target detected once is detected at substantially the same position thereafter”. The simplified determination process does not use a complicated tracking algorithm, and thus the processing load is smaller compared with the tracking process. The target recognition system 1 finally determines the temporary stationary target which the simplified determination process determines to actually exist as the actually present target, and outputs the recognition result of the determined existence to a subsequent process.

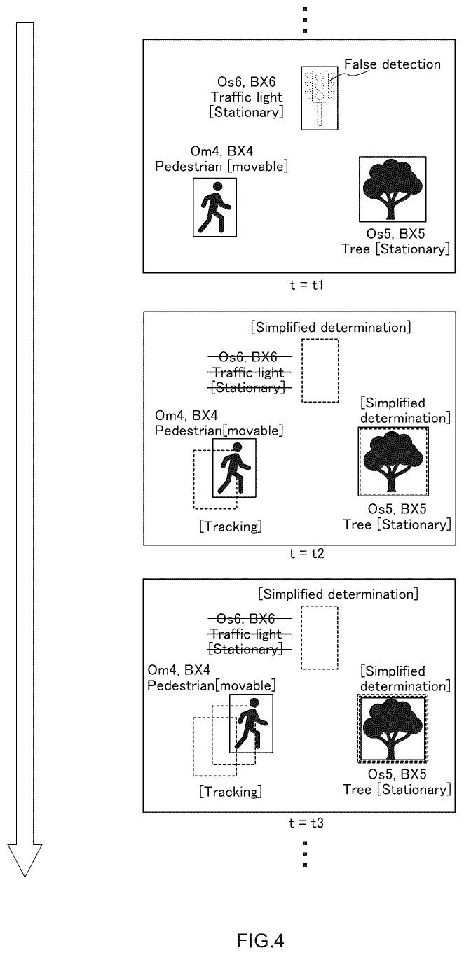

FIG. 4 is a schematic diagram for explaining the simplified determination process for each time step. As in FIG. 2, FIG. 4 shows a serial images IMG at different time steps (t=t1, t2, t3, . . . ) included in the video.

At t=t1, the target and class detection by the target detection unit 11 is completed. Each target is provided with the bounding box BX and an indication of “movable” or “stationary”. The bounding box BX4 is provided to a pedestrian (a movable target). This target (the pedestrian) is referred to as a temporary movable target Om4. A bounding box BX5 is provided to a tree (a stationary target). This target (tree) is referred to as a temporary stationary target Os5. The bounding box BX6 is provided to a traffic light (a stationary target). This target (traffic light) is referred to as a temporary stationary target Os6. Here, it is assumed that the temporary stationary target Os6 does not really exist (that is, the target detection unit 11 has falsely detected the target Os6).

The tracking process is applied to the temporary movable target Om4, as shown in FIG. 2. When the tracking is interrupted in the middle of the tracking process, there is a possibility of false detection as in the case of the target O1 in FIG. 2. In FIG. 4, the temporary movable target Om4 is continuously tracked until t=t3, which means that the temporary movable target Om4 can be determined to actually exist (a real movable target).

The temporary stationary target Os5 is continuously detected at substantially the same position in the image IMG until t=t3. The fact that a certain temporary stationary target is continuously detected at substantially the same position for a predetermined period of time, such as a temporary stationary target Os5, is an example of an existence determination condition. Therefore, the target detection unit 11 determines that the temporary stationary target Os5 is a real target. Details and other examples of the existence determination condition will be described later.

On the other hand, the temporary stationary target Os6 is not detected at t=t2 and t3. In such a case, it is considered that the existence determination condition is not satisfied. Therefore, the target detection unit 11 determines that the temporary stationary target Os6 is detected although it does not actually exist (that is, false detection).

### 2-3. Existence Determination Conditions

The existence determination condition (the condition for determining that the temporary stationary target is a real stationary target) will be described below.

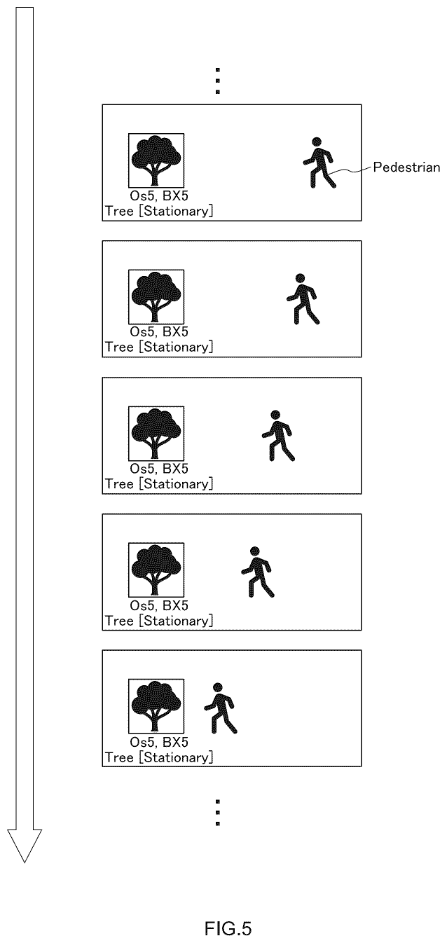

An example of the existence determination condition is that “the temporary stationary target is detected in X (X is an integer of 2 or more) frames in succession at substantially the same position in the images IMG”. FIG. 5 is a schematic diagram for explaining an example of the existence determination condition where X=5. FIG. 5 shows five frames extracted from the serial images IMG. In the figure, the temporary stationary target Os5 and a pedestrian are depicted.

In FIG. 5, the pedestrian is approaching the temporary stationary target Os5, but does not overlap it. That is, the temporary stationary target Os5 is not hidden from the view of the infrastructure camera 10 by the pedestrian. Therefore, the temporary stationary target Os5 is detected in five consecutive frames at substantially the same position in the image IMG. Therefore, the target detection unit 11 determines that the temporary stationary target Os5 is an existing target. In this way, when a certain temporary stationary target is detected in a plurality of consecutive frames, the target detection unit 11 determines that the temporary stationary target is a real target.

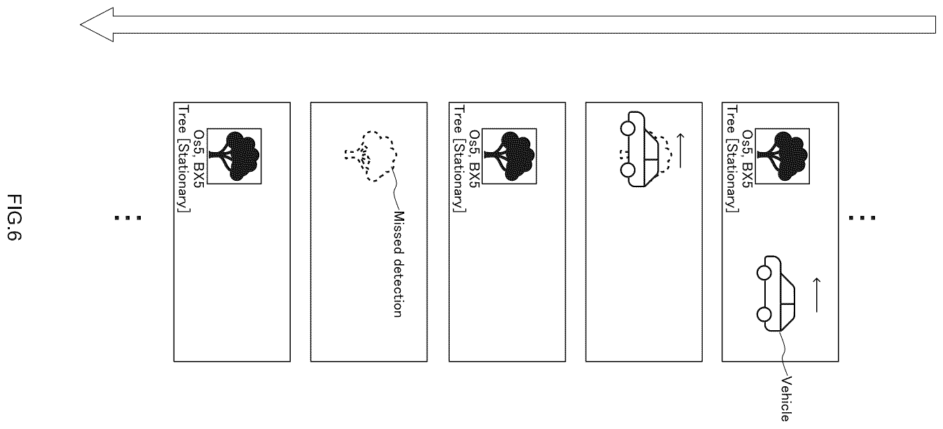

Another example of the existence determination condition is that “the temporary stationary target is detected Y (Y is an integer of 2 or more) times or more in a predetermined period at substantially the same position in the image IMG”. FIG. 6 is a schematic diagram for explaining another example of the existence determination condition (five frames of the serial images IMG are extracted as in FIG. 5). In the second frame, most of the temporary stationary target Os5 is hidden from the view of the infrastructure camera 10 by a passing vehicle. Therefore, the target detection unit 11 fails to continuously detect the temporary stationary target Os5 (the bounding box BX is not provided). In the fourth frame, the temporary stationary target Os5 is not hidden by another object, but is not detected. For example, the target detection unit 11 cannot appropriately detect the temporary stationary target Os5 due to a temporary light environment etc. (missed detection). In the case of such a temporary detection failure, it is not appropriate to determine that the temporary stationary target Os5 does not exist (false detection). Therefore, when a certain temporary stationary target is detected multiple times during a predetermined period, it is appropriate for the target detection unit 11 to determine that the temporary stationary target is a real target. For example, if the existence determination condition is “three or more detections in five frames”, the target detection unit 11 determines that the temporary stationary target Os5 is a real target since the temporary stationary target Os5 is detected three times in five frames in the situation shown in FIG. 6.

The existence determination condition as described above can be used to a temporary movable target, that is, an existence determination condition in the tracking process. In this case, the “temporary stationary target” in the above-described condition may be read as the “temporary movable target”. The “predetermined period” used for the determination of the existence determination condition may be different between the case of the temporary stationary target and the case of the temporary movable target. That is, a “first period” may be set for the temporary movable target, and a “second period” may be set for the temporary stationary target.

### 2-4. Effect

As described above, the target recognition system 1 executes the simplified determination process on the temporary stationary target instead of the tracking process. Therefore, the target recognition system 1 can reduce the processing load as compared with the case where the tracking process is applied to all targets regardless of the class. In particular, when the tracking process is applied to multiple targets simultaneously in parallel, the increase in the processing load is significant. Therefore, it is particularly effective to use the target recognition system 1 when multiple targets are shown in the serial images IMG.

Further, by outputting the recognition result of the target satisfying the existence determination condition to a subsequent process, unnecessary processes and operations in the subsequent process can be reduced. This leads to reducing processing load in the subsequent process. Further, frequent occurrence of unnecessary processes and operations (for example, false detection of an abnormality by an abnormality monitoring system in the city) may lead to user's anxiety and distrust. Therefore, the target recognition system 1 outputs the result of the simplified determination process to the subsequent process, thereby contributing to an increase in the reliability of the subsequent process.

### 3. CONFIGURATION EXAMPLE

### 3-1. Configuration Example

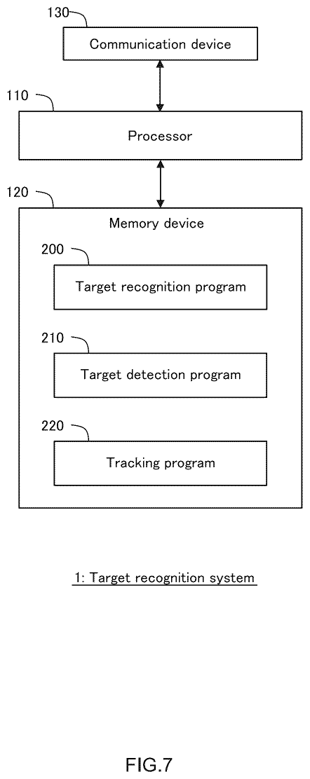

FIG. 7 is a block diagram showing an example of a configuration of the target recognition system 1. The target recognition system 1 includes one or more processors 110 (hereinafter, simply referred to as “processor 110”), one or more memory devices 120 (hereinafter, simply referred to as “memory device 120”), and a communication device 130.

The processor 110 performs various processes. For example, the processor 110 includes a central processing unit (CPU). The processor 110 can be referred to as processing circuitry. The memory device 120 stores a variety of information necessary for processing. Examples of the memory device 120 include a volatile memory, a nonvolatile memory, a hard disk drive (HDD), and a solid-state drive (SSD).

The target recognition program 200 is a computer program that performs a target recognition process. The target recognition program 200 is stored in the memory device 120. The target recognition program 200 may be recorded in a non-transitory computer-readable recording medium. The target recognition program 200 is executed by the processor 110. The functions of the target recognition system 1 are realized by the cooperation of the processor 110, which executes the target recognition program 200, and the memory device 120.

The processor 110 communicates with the infrastructure camera 10 via the communication device 130 and acquires the serial images IMG. The processor 110 also performs the target detection, the tracking process, and the simplified determination process. That is, the processor 110 functions as the target detection unit 11 and the tracker 12, which are subjects of each process. A target detection program 210 used for the target detection and the tracking program 220 used for tracking processing are stored in the memory device 120. The target detection program 210 and the tracking program 220 may be recorded in a computer-readable recording medium.

### 3-2. Process Flow

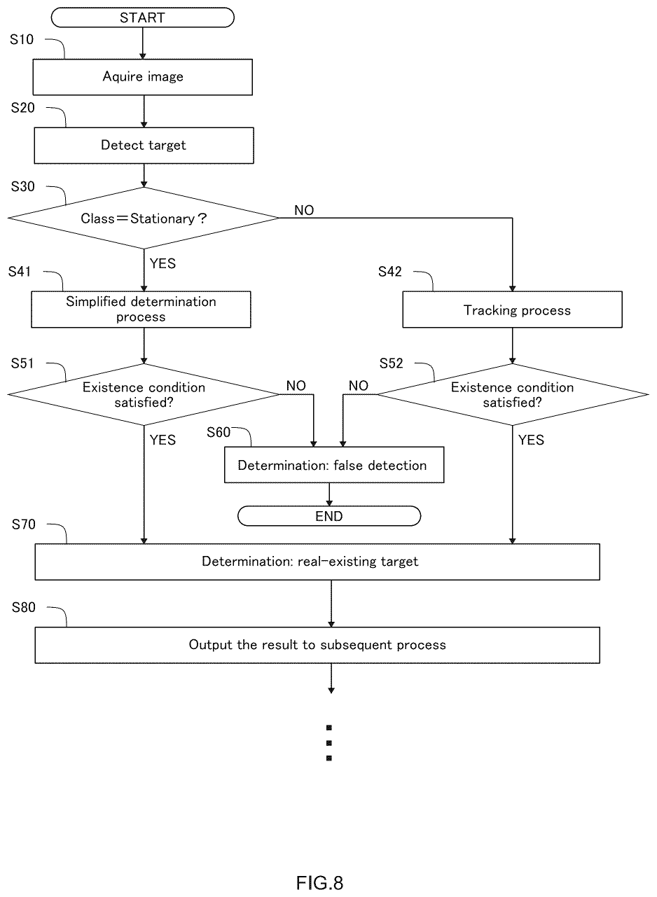

FIG. 8 is a flowchart illustrating a series of processes related to the target recognition system 1.

In step S10, the processor 110 acquires a serial images IMG from the infrastructure camera 10 via the communication device 130. Thereafter, the process proceeds to step S20.

In step S20, the processor 110 detects the target shown in the serial images IMG and the class, and provides the bounding box BX to each target. Thereafter, the process proceeds to step S30.

In step S30, the processor 110 refers to the class of the temporary target detected in step S20. In a case where the class of the temporary target is a stationary target (step S30; Yes), the process proceeds to step S41. On the other hand, in a case where the class of the temporary target is not a stationary target (that is, the temporary target is a movable target) (step S30; No), the process proceeds to step S42.

In step S41, the processor 110 performs the simplified determination process on the temporary target (in this case, the temporary stationary target). Thereafter, the process proceeds to step S51.

In step S42, the processor 110 applies the tracking process to the temporary target (in this case, the temporary movable target). Thereafter, the process proceeds to step S52.

In steps S51 and S52, the processor 110 determines whether the existence determination condition is satisfied. When the existence determination condition is satisfied (step S51 or S52; Yes), the process proceeds to step S70. On the other hand, when the existence determination condition is not satisfied (step S51 or S52; No), the process proceeds to step S60.

In step S60, the processor 110 determines that the temporary target detected in step S20 is falsely detected. Thereafter, the process is terminated. Since the information of the temporary target determined as the false detection is not output to the subsequent process, it is possible to reduce unnecessary processes and operations in the subsequent process.

In step S70, the processor 110 determines that the temporary target detected in step S20 is a real target (the real existence determined). Thereafter, the process proceeds to step S80.

In step S80, the processor 110 outputs the result of recognition the determined existence to the subsequent process. Since the result does not include the target which does not satisfy the existence determination condition, it is possible to reduce unnecessary processes and system operations in the subsequent process.

What is claimed is:

1. A target recognition system for recognizing a target shown in an image captured by an infrastructure camera, the target recognition system comprising:
processing circuitry configured to:
detect a first target shown in the image as a temporary target;
when a class of the temporary target is a movable target, apply a tracking process to the temporary target and determine that the first target is a real movable target based on a result of detection of the temporary target in a first period; and
when the class of the temporary target is a stationary target, determine that the first target is a real stationary target based on a result of detection of the temporary target in a second period without applying the tracking process to the temporary target.

2. The target recognition system according to claim 1, wherein
the second period is a period of X frames (X is an integer of 2 or more), and
when the class of the temporary target is the stationary target and the temporary target is detected in the X frames in succession, the processing circuitry determines that the first target is the real stationary target.

3. The target recognition system according to claim 1, wherein
when the class of the temporary target is the stationary target and the temporary target is detected Y times or more (Y is an integer of 2 or more) in the second period, the processing circuitry determines that the first target is the real stationary target.

4. The target recognition system according to claim 1, wherein
the processing circuitry outputs a result of determining that the first target is the real movable target or the real stationary target to a subsequent process.

5. A target recognition method for recognizing a target shown in an image captured by an infrastructure camera, the target recognition method comprising:
detecting a first target in the image as a temporary target;
when a class of the temporary target is a movable target, applying a tracking process to the temporary target, and determining that the first target is a real movable target based on a result of detection of the temporary target in a first period; and
when the class of the temporary target is a stationary target, determining that the first target is a real stationary target based on a result of detection of the temporary target in a second period without applying the tracking process to the temporary target.

6. A non-transitory computer-readable recording medium on which a target recognition program is recorded, wherein
the target recognition program is for recognizing a target shown in an image captured by an infrastructure camera,
the target recognition program, when executed by a computer, causes the computer to execute:
detecting a first target in the image as a temporary target;
when a class of the temporary target is a movable target, applying a tracking process to the temporary target, and determining that the first target is a real movable target based on a result of detection of the temporary target in a first period; and
when the class of the temporary target is a stationary target, determining that the first target is a real stationary target based on a result of detection of the temporary target in a second period without applying the tracking process to the temporary target.
